(19) United States
(12) Patent Application Publication
(10) Pub. No.: US 2026/0046860 A1
(43) Pub. Date: Feb. 12, 2026

(54) CAPABILITY REPORTING METHOD, DEVICE AND STORAGE MEDIUM

(71) Applicant: BEIJING XIAOMI MOBILE SOFTWARE CO., LTD., Beijing (CN)

(72) Inventors: Juan ZHANG, Beijing (CN); Yumin WU, Beijing (CN)

(21) Appl. No.: 18/995,778

(22) PCT Filed: Jul. 22, 2022
(86) PCT No.: PCT/CN2022/107530

§ 371 Date: Jan. 16, 2025

(51) Int. Cl. H04W 72/115; H04B 7/06; H04W 72/21

(52) U.S. Cl. CPC H04W 72/115; H04B 7/06952; H04W 72/21

(57) ABSTRACT

A capability reporting method is performed by a terminal device, and includes: transmitting, by the terminal device in a connected state, capability indication information to a network-side device, in which the capability indication information is configured indicate that the terminal device supports beam correspondence in a configured grant small data transmission (CG-SDT) procedure.

### CROSS-REFERENCE TO RELATED APPLICATION

The present application is a U.S. National Stage of International Application No. PCT/CN2022/107530, filed on Jul. 22, 2022, the contents of all of which are incorporated herein by reference in their entireties for all purposes.

### BACKGROUND

In related technologies, in a CG-SDT (Configured Grant Small Data Transmission) procedure, a terminal device in a non-connected state does not support the beam correspondence, and does not support reporting to the network-side device a capability that the terminal device supports the beam correspondence in the CG-SDT procedure, which is an issue that needs to be solved urgently.

### SUMMARY

The present disclosure relates to the field of communication technologies, and in particular to a capability reporting method and apparatus, a communication device and a storage medium.

In a first aspect, an embodiment of the present disclosure provides a capability reporting method, which is performed by a terminal device. The method includes: transmitting, by the terminal device in a connected state, capability indication information to a network-side device, where the capability indication information is used to indicate that the terminal device supports beam correspondence in a configured grant small data transmission (CG-SDT) procedure.

In a second aspect, an embodiment of the present disclosure provides another capability reporting method, which is performed by a network-side device. The method includes: receiving capability indication information transmitted by a terminal device in a connected state, where the capability indication information is used to indicate that the terminal device supports beam correspondence in a configured grant small data transmission (CG-SDT) procedure.

In a third aspect, an embodiment of the present disclosure provides a communication device that has some or all of the functions of the terminal device for implementing the method described in the above first aspect. For example, the functions of the communication device may include functions of some or all of the embodiments in the present disclosure, or may include functions for independently implementing any of the embodiments of the present disclosure. The functions described may be implemented by hardware, or may be implemented by hardware executing corresponding software. The hardware or software includes one or more units or modules corresponding to the above functions.

In a fourth aspect, an embodiment of the present disclosure provides another communication device that has some or all of the functions of the network-side device for implementing the method described in the above second aspect. For example, the functions of the communication device may include functions of some or all of the embodiments in the present disclosure, or may include functions for independently implementing any of the embodiments of the present disclosure. The functions described may be implemented by hardware, or may be implemented by hardware executing corresponding software. The hardware or software includes one or more units or modules corresponding to the above functions.

In a fifth aspect, an embodiment of the present disclosure provides a communication device. The communication device includes a processor. When invoking a computer program in a memory, the processor is configured to execute the method described in the above first aspect.

In a sixth aspect, an embodiment of the present disclosure provides a communication device. The communication device includes a processor. When invoking a computer program in a memory, the processor is configured to execute the method described in the above second aspect.

In a seventh aspect, an embodiment of the present disclosure provides a communication device. The communication device includes a processor and a memory, and a computer program is stored in the memory. The processor is configured to execute the computer program stored in the memory to cause the communication device to perform the method described in the above first aspect.

In an eighth aspect, an embodiment of the present disclosure provides a communication device. The communication device includes a processor and a memory, and a computer program is stored in the memory. The processor is configured to execute the computer program stored in the memory to cause the communication device to perform the method described in the above second aspect.

In a ninth aspect, an embodiment of the present disclosure provides a communication device. The device includes a processor and an interface circuit. The interface circuit is configured to receive code instructions and transmit them to the processor. The processor is configured to execute the code instructions to cause the device to execute the method described in the above first aspect.

In a tenth aspect, an embodiment of the present disclosure provides a communication device. The device includes a processor and an interface circuit. The interface circuit is configured to receive code instructions and transmit them to the processor. The processor is configured to execute the code instructions to cause the device to perform the method described in the above second aspect.

In an eleventh aspect, an embodiment of the present disclosure provides a capability reporting system. The system includes the communication device according to the third aspect and the communication device according to the fourth aspect, or the system includes the communication device described in the fifth aspect and the communication device according to the sixth aspect, or the system includes the communication device according to the seventh aspect and the communication device according to the eighth aspect, or the system includes the communication device according to the ninth aspect and the communication device according to the tenth aspect.

In a twelfth aspect, an embodiment of the present invention provides a computer-readable storage medium, configured to store instructions used by the above-mentioned terminal device. The instructions, when executed, cause the terminal device to execute the method as described in above first aspect.

In a thirteenth aspect, an embodiment of the present invention provides a readable storage medium, configured to store instructions used by the above-mentioned network-side device. The instructions, when executed, cause the network-side device to execute the method as described in above second aspect.

In a fourteenth aspect, the present disclosure further provides a computer program product, including a computer program that, when executed by a computer, causes the computer to execute the method described in the above first aspect.

In a fifteenth aspect, the present disclosure further provides a computer program product, including a computer program that, when executed by a computer, causes the computer to execute the method described in the above second aspect.

In a sixteenth aspect, the present disclosure provides a chip system. The chip system includes at least one processor and an interface for supporting a terminal device to implement the functions involved in the first aspect, for example, determining or processing at least one of data or information involved in the above method. In a possible design, the chip system further includes a memory, and the memory is configured to store necessary computer programs and data for the terminal device. The chip system may be composed of chips, or may include a chip and other discrete devices.

In a seventeenth aspect, the present disclosure provides a chip system. The chip system includes at least one processor and an interface for supporting a network-side device to implement the functions involved in the second aspect, for example, determining or processing at least one of data or information involved in the above method. In a possible design, the chip system further includes a memory, and the memory is configured to store necessary computer programs and data for the network-side device. The chip system may be composed of chips, or may include a chip and other discrete devices.

In an eighteenth aspect, the present disclosure provides a computer program that, when running on a computer, causes a computer to perform the method described in the above first aspect.

In a nineteenth aspect, the present disclosure provides a computer program that, when running on a computer, causes a computer to perform the method described in the above second aspect.

### BRIEF DESCRIPTION OF THE DRAWINGS

In order to more clearly explain technical solutions in embodiments of the present disclosure or the background technology, drawings required to be used in the embodiments of the present disclosure or the background technology will be described below.

FIG. 1 is an example diagram of a SDT procedure.

FIG. 2 is an example diagram of a CG-SDT retransmission procedure.

FIG. 3 is an architectural diagram of a communication system provided by an embodiment of the present disclosure.

FIG. 4 is a flow chart of a capability reporting method provided by an embodiment of the present disclosure.

FIG. 5 is a flow chart of a capability reporting method provided by an embodiment of the present disclosure.

FIG. 6 is a flow chart of another capability reporting system provided by an embodiment of the present disclosure.

FIG. 7 is a flow chart of another capability reporting system provided by an embodiment of the present disclosure.

FIG. 8 is a flow chart of another capability reporting system provided by an embodiment of the present disclosure.

FIG. 9 is a flow chart of another capability reporting method provided by an embodiment of the present disclosure.

FIG. 10 is a flow chart of another capability reporting system provided by an embodiment of the present disclosure.

FIG. 11 is a flow chart of another capability reporting system provided by an embodiment of the present disclosure.

FIG. 12 is a flow chart of another capability reporting system provided by an embodiment of the present disclosure.

FIG. 13 is a flow chart of another capability reporting system provided by an embodiment of the present disclosure.

FIG. 14 is a structural diagram of a communication device provided by an embodiment of the present disclosure.

FIG. 15 is a structural diagram of another communication device provided by an embodiment of the present disclosure.

FIG. 16 is a schematic structural diagram of a chip provided by an embodiment of the present disclosure.

### DETAILED DESCRIPTION

Exemplary embodiments will be described in detail herein, examples of which are illustrated in the accompanying drawings. The following description refers to the accompanying drawings in which the same numbers in different drawings refer to the same or similar elements unless otherwise indicated. The implementations set forth in the following description of illustrative embodiments do not represent all implementations consistent with the embodiments of the present disclosure. They are merely examples of apparatuses and methods consistent with some aspects of the embodiments of the present disclosure as recited in the appended claims.

Terms used in the embodiments of the present disclosure are only for the purpose of describing specific embodiments, and shall not be construed to limit the present disclosure. As used in the embodiments of the present disclosure and the appended claims, “a/an” and “the” in a singular form are intended to include plural forms, unless clearly indicated in the context otherwise. It should be understood that, the term “and/or” used herein represents and contains any one of associated listed items and all possible combinations of more than one associated listed items.

It will be further appreciated that although operations are described in a specific order in the drawings in the embodiments of the present disclosure, this should not be understood as requiring these operations to be performed in the specific order as illustrated or in a serial order, or requiring all the operations as illustrated to be performed to obtain a desired result. In certain circumstances, multitasking and parallel processing may be advantageous.

In order to facilitate understanding of the technical solutions of the present disclosure, some terms involved in the embodiments of the present disclosure will be briefly introduced below.

### 1. Beam

The beam may be a spatial domain filter, also known as a spatial filter or a spatial parameter. A beam for transmitting signals may be referred to as a transmission beam (Tx beam), a spatial domain transmission filter, or a spatial transmission parameter. A beam for receiving signals may be referred to as a reception beam (Rx beam), a spatial domain receive filter, or a spatial receive parameter (spatial RX parameter).

The transmission beam may refer to a distribution of signal strengths in different directions in space after a signal is transmitted by an antenna, and the reception beam may refer to a distribution of signal strengths of a wireless signal received from an antenna in different directions in space.

In addition, the beam may be a wide beam, a narrow beam, or other types of beams. The technique for forming the beam may be beamforming technique or other techniques. Specifically, the beamforming technique may be digital beamforming technique, analog beamforming technique, or hybrid digital/analog beamforming technique.

Beams generally correspond to resources. For example, when performing beam measurement, a network-side device may use different beams to transmit signals on different resources, a terminal device may use different beams to receive signals in different resources, and the terminal device may feed back qualities of signals measured on different resources to the network-side device, so that the network-side device knows the qualities of the corresponding beams. During data transmission, beam information is also indicated by a resource corresponding to it. For example, the network-side device indicates physical downlink shared channel (PDSCH) beam information to the terminal device by using a transmission configuration indicator (TCI) resource in downlink control information (DCI).

Alternatively, multiple beams having the same or similar communication characteristics may be regarded as one beam.

One beam corresponds to one or more antenna ports and is used to transmit data channels, control channels, detection signals, etc. One or more antenna ports corresponding to one beam may also be taken as an antenna port set.

In beam measurement, each beam of the network-side device corresponds to a resource, so a beam corresponding to a resource may be uniquely identified through an identifier (or index) of the resource.

### 2. Beam Correspondence

The terminal device may determine its own uplink transmission beam based on a downlink reception beam or determine its own downlink reception beam based on an uplink transmission beam. For example, if a reception beam A is a better/optimal choice for receiving downlink signals, the terminal device infers from the downlink reception beam A that its corresponding uplink transmission beam A′ is also a better/optimal uplink transmission beam. If the network-side device indicates a downlink reference signal X corresponding to a certain downlink reception beam A, the terminal device may know its corresponding transmission beam A′ based on the reception beam A corresponding to the received signal X.

### 3. Small Data Transmission (SDT)

Generally, data may be transmitted between a terminal device and a network-side device only when the terminal device is in an RRC connected state (CONNECTED). However, in some scenarios, the terminal device in RRC idle state (IDLE) or RRC inactive state (INACTIVE) needs to transmit a quite small data packet, and this type of data packet may be referred to as small data packet (small data). A signaling required by the terminal device entering the RRC CONNECTED state from the RRC IDLE state or the RRC INACTIVE state is even larger than the small data, resulting in unnecessary power consumption and signaling overhead of the terminal device. In order to avoid the above situation, the terminal device in the RRC IDLE state or the RRC INACTIVE state may transmit small data in a random access (RA) procedure or transmit small data on a resource configured by the network-side device without entering the RRC CONNECTED state.

The above transmission procedure may be referred to as SDT (small data transmission), and the manner in which the terminal device transmits small data on the resource configured by the network-side device may be referred to as CG-SDT (Configured Grant small data transmission).

According to the resource configured on the network side, when the terminal device is in a non-connected state, such as IDLE (idle) or INACTIVE (inactive) state, the terminal device may directly transmit data to the network-side device in the following manners:
1) by means of Msg3 in the four-step random access procedure for initial access (or known as 4-step RACH SDT);
2) by means of MsgA in the two-step random access procedure for initial access (or known as 2-step RACH SDT);
3) by means of a dedicated uplink PUSCH (Physical Uplink Shared Channel) resource configured by the network (i.e., CG (Configured Grant) or PUR (Preallocated Uplink Resource)); which is also referred to as CG SDT.

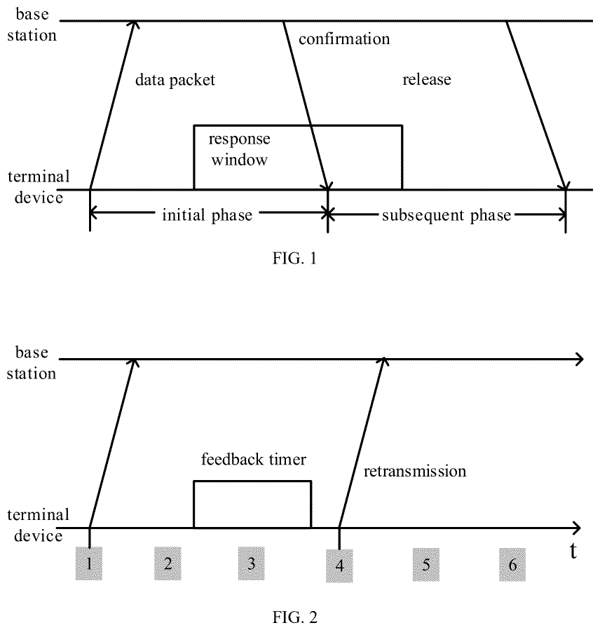

As shown in FIG. 1, the SDT procedure may include an initial data transmission phase and a subsequent data transmission phase.

The initial data transmission phase starts when SDT initial data transmission is triggered, and ends when confirmation information for the initial data is received from the network side.

The confirmation information may have the following three different forms considering different SDT procedures:
(1) 4-step RACH SDT: confirmation information is a contention resolution identifier of successfully received Msg4;
(2) 2-step RACH SDT: confirmation information is a contention resolution identifier of successfully received MsgB;
(3) CG-SDT: confirmation information is a data reception success indication transmitted by the network-side device (such as ACK (acknowledge) information indicated by physical layer DCI (Downlink Control Information)).

The subsequent data transmission phase starts when the confirmation information of the initial data is received from the network-side device, and ends when a connection release message is received from the network-side device. In this phase, the terminal device may transmit and receive uplink and downlink data.

In the subsequent data transmission phase of the CG-SDT procedure, the terminal device may monitor a PDCCH (Physical downlink control channel) to receive a C-RNTI (Cell Radio Network Temporary Identifier) and may transmit a CG-PUSCH subsequently, and before receiving a connection release message transmitted by the network-side device, the terminal device may persistently monitor the PDCCH and then transmit the CG-PUSCH.

There is a relevant mapping relationship between an SSB (Synchronization Signal and PBCH block) beam and a CG-PUSCH.

As shown in FIG. 2, FIG. 2 is an example diagram of a CG-SDT retransmission procedure. For a CG-SDT resource configured by the network-side device, the terminal device transmits data by using the CG resource, and then may start a feedback timer (for example, feedback Timer) to monitor feedback information from the network-side device. If the terminal device does not receive successful reception confirmation from the network-side device during the running of the feedback timer, the terminal device will perform data retransmission on subsequent CG resources to perform CG-SDT retransmission. For uplink configured grant (Configured Grant), every time when the terminal device transmits uplink new data transmission in a HARQ process, a configured grant timer corresponding to the HARQ process will be started, and no other new transmission will be scheduled in the HARQ process while the timer is running. A configured grant retransmission timer (CG-RetransmissionTimer) may be configured Per Configured Grant, and is used for automatic uplink retransmission. Each time when the terminal device transmits an uplink new transmission or retransmission in a HARQ process, a CG-RetransmissionTimer corresponding to the HARQ process will be started. During the running of the timer, uplink automatic retransmission will not be performed. After the timer stops running, automatic uplink retransmission is started.

### 4. QCL (Quasi-collocation)

Quasi-collocation (QCL) means that a large-scale parameter of a channel experienced by symbols on one antenna port may be inferred from a channel experienced by symbols on another antenna port. The large-scale parameter may include delay spread, average delay, Doppler spread, Doppler shift, average gain, spatial reception parameter, etc.

The concept of QCL was introduced with the emergence of the coordinated multiple point transmission (COMP) technique. Multiple sites involved in a CoMP transmission procedure may correspond to multiple sites with different geographical locations or multiple sectors with different antenna panel orientations. For example, when a terminal device receives data from different sites, spatial differences of different sites may lead to differences in large-scale channel parameters of reception links between or among different sites, such as Doppler frequency offset, delay spread, etc. A large-scale parameter of a channel may directly affect adjustment and optimization of filter coefficients during channel estimation. Corresponding to signals transmitted by different sites, different channel estimation filter parameters should be used to adapt to corresponding channel propagation characteristics.

Therefore, although spatial positions or angle differences of various sites are transparent to UE and the CoMP operation, the impact of the above spatial differences on the large-scale parameter of the channel is a crucial factor that needs to be considered when the terminal device performs channel estimation and reception detection. The so-called QCL of two antenna ports in the sense of certain large-scale parameters means that these large-scale parameters of the two ports are the same. In other words, as long as certain large-scale parameters of the two ports are consistent, the terminal device may consider the two ports as originating from the same location (i.e., quasi-co-located), regardless of whether there are differences in their actual physical locations or orientations of corresponding antenna panels.

For some typical application scenarios, considering possible QCL relationships between various reference signals, from the perspective of simplifying signaling, several large-scale channel parameters are divided into the following four types in NR, to facilitate configuration/indication by a system according to different scenarios.
1) QCL-TypeA: {Doppler frequency shift, Doppler spread, average delay, delay spread}
Except for the spatial reception parameters, the other large-scale parameters are the same.
For frequency bands below 6 GHz, spatial reception parameters may not be required.
2) QCL-TypeB:{Doppler frequency shift, Doppler spread}
Only for the following two situations in frequency bands below 6 GHz
3) QCL-TypeC: {Doppler frequency shift, average delay}
4) QCL-TypeD:{space receiving parameter}

As mentioned before, since the parameter is mainly targeted at frequency bands above 6 GHz, it is taken as a separate QCL type.

In order to better understand the capability reporting method and apparatus disclosed in embodiments of the present disclosure, the following first describes a communication system to which the embodiments of the present disclosure are applicable.

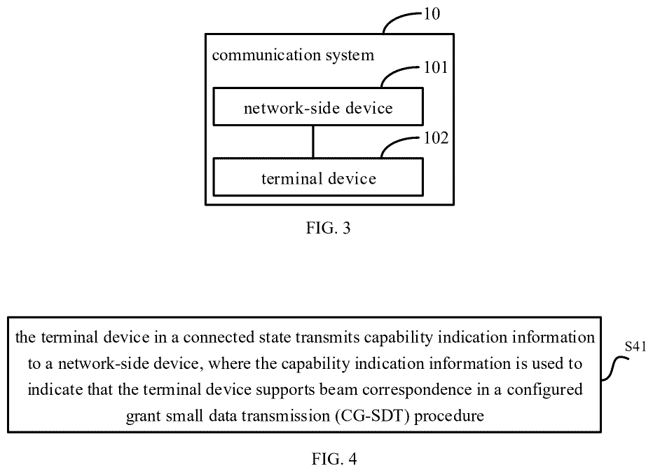

Referring to FIG. 3, FIG. 3 is a schematic architectural diagram of a communication system provided by an embodiment of the present disclosure. The communication system may include, but not limited to, one network-side device and one terminal device. The number and form of devices shown in FIG. 3 are only for examples and do not constitute a limitation on the embodiments of the present disclosure. In actual applications, the system may include two or more of network-side devices mentioned above, and two or more of terminal devices mentioned above. The communication system 10 shown in FIG. 3 may include one network-side device 101 and one terminal device 102, which is taken as an example.

It should be noted that the technical solutions of the embodiments of the present disclosure may be applied to various communication systems, for example: long term evolved (LTE) system, 5th generation (5G) mobile communication system, 5G new radio (NR) system, or other future new mobile communication systems. It should also be noted that a sidelink in the embodiments of the present disclosure may be referred to as a side link or a direction communication link.

The network-side device 101 in the embodiments of the present disclosure is an entity on the network side for receiving or transmitting signals. For example, the network-side device 101 may be an evolved NodeB (eNB), a transmission reception point (TRP), a next generation NodeB (gNB) in an NR system, a base station in other future mobile communication systems, an access node in a wireless fidelity (WiFi) system, or the like. The specific technique and the specific device form used by the base station are not limited in the embodiments of the present disclosure. The base station provided by the embodiments of the present disclosure may include a centralized unit (CU) and a distributed unit (DU). The CU may also be referred to as a control unit. Protocol layers of the base station may be split by means of the structure of CU-DU, where functions of some protocol layers are arranged on the CU for centralized control, some or all of functions of the remaining protocol layers are distributed in the DU, and the CU centrally controls the DU.

The terminal device 102 in the embodiments of the present disclosure is an entity on the user side for receiving or transmitting signals, such as a mobile phone. The terminal device may also be referred to as terminal, user equipment (UE), mobile station (MS), mobile terminal (MT), etc. The terminal device may be a car with communication functions, a smart car, a mobile phone, a wearable device, a tablet computer (Pad), a computer with wireless transceiver functions, a virtual reality (VR) terminal, an augmented reality (AR) terminal, a wireless terminal in industrial control, a wireless terminal in self-driving, a wireless terminal in remote medical surgery, a wireless terminal in a smart grid, a wireless terminal in transportation safety, a wireless terminal in smart city, a wireless terminal in smart home, etc. The specific technique and the specific device form used by the terminal device are not limited in the embodiments of the present disclosure.

It will be appreciated that the communication system described in the embodiments of the present disclosure is to more clearly illustrate the technical solutions of the embodiments of the present disclosure, and does not constitute a limitation on the technical solutions provided by the embodiments of the present disclosure. As those of ordinary skill in the art will know, with the evolution of the system architecture and the emergence of new service scenarios, the technical solutions provided by the embodiments of the present disclosure are also applicable to similar technical problems.

In the communication system, the communication protocol stack between the terminal device and the network-side device may include an RRC (radio resource control) layer. States of the terminal device may include a connected state (also referred to as RRC_CONNCETED state), an inactive state (also referred to as RRC_INACTIVE state), and an idle state (also referred to as RRC_IDLE state).

It should be noted that in the full description of the embodiments of the present disclosure, a terminal device in a non-connected state may be that the terminal device is in an idle state, or in an inactive state, or in a state other than the connected state; the terminal device in a non-connected state may be that the terminal device is in an idle state, or in an inactive state, or in a state other than the connected state.

In the embodiments of the present disclosure, “used to indicate” may include direct indicating and indirect indicating. When describing certain indication information used to indicate A, it may include that the indication information directly indicates A or indirectly indicates A, but it does not mean that the indication information must include A.

The capability reporting method and apparatus provided by the present disclosure will be introduced in detail below with reference to the accompanying drawings.

Referring to FIG. 4, FIG. 4 is a flow chart of a capability reporting method provided by an embodiment of the present disclosure.

As shown in FIG. 4, the method is performed by a terminal device. The method may include, but not limited to, the following steps.

In step S41, the terminal device in a connected state transmits capability indication information to a network-side device, where the capability indication information is used to indicate that the terminal device supports beam correspondence in a configured grant small data transmission (CG-SDT) procedure.

This is to address the problem in related technologies that the terminal device is not supported to report a capability of supporting the beam correspondence in the CG-SDT procedure.

In the embodiment of the present disclosure, the terminal device in the connected state may transmit the capability indication information to the network-side device, where the capability indication information is used to indicate that the terminal device supports the beam correspondence in the CG-SDT procedure. In this way, the terminal device can be supported to report to the network-side device that the terminal device has the capability to support the beam correspondence in the CG-SDT procedure.

The terminal device may transmit an information field (IE) of beamcorrespondence-cg-SDT-r18 ENUMERATED {supported} to the network-side device to transmit the capability indication information to the network-side device, so as to report that the terminal device has the capability to support the beam correspondence in the CG-SDT procedure.

In some embodiments, the terminal device supporting the beam correspondence refers to that the terminal device may determine an uplink transmission beam based on a downlink reception beam without performing uplink beam scanning.

It is understood that when a terminal device does not support the beam correspondence, the terminal device needs to perform uplink beam scanning to determine a beam with better or best beam quality as the uplink transmission beam, and then performs the CG-SDT by using the uplink transmission beam to transmit a small data packet to the network-side device.

However, in the embodiment of the present disclosure, the terminal device supports the beam correspondence in the CG-SDT procedure, and the terminal device may determine the uplink transmission beam according to the downlink reception beam used by a dedicated PUSCH resource configured by the network-side device, and may transmit the small data packet to the network-side device on the dedicated PUSCH resource by using the determined uplink transmission beam, to perform the CG-SDT and/or perform CG-SDT retransmission. Therefore, the terminal device does not need to perform uplink beam scanning to determine the uplink beam, which can save energy consumption of the terminal device. Moreover, the terminal device does not need to perform beam scanning to determine a candidate uplink transmission beam, which can reduce delay.

In some embodiments, the terminal device in the connected state receives a radio resource control (RRC) release message transmitted by the network-side device, and switches to a non-connected state, where the RRC release message is used to indicate the dedicated physical uplink shared channel (PUSCH) resource for CG-SDT; the terminal device in the non-connected state determines the candidate uplink transmission beam according to a candidate downlink reception beam for receiving the RRC release message; and the terminal device in the non-connected state performs the CG-SDT and/or performs CG-SDT retransmission by using the candidate uplink transmission beam on the dedicated PUSCH resource.

In the embodiment of the present disclosure, the terminal device in the connected state receives the RRC connection release message transmitted by the network-side device and switches to the non-connected state. The network-side device transmits the RRC connection release message to the terminal device in the connected state, and QCL information may be released synchronously.

The RRC connection release message transmitted by the network-side device to the terminal device in the connected state is used to indicate the dedicated PUSCH resource for CG-SDT.

In the embodiments of the present disclosure, after the terminal device in the connected state receives the RRC connection release message transmitted by the network-side device, the terminal device switches from the connected state to the non-connected state. The terminal device in the non-connected state may determine the candidate downlink reception beam for receiving the RRC release message. Since the terminal device supports the beam correspondence in the CG-SDT procedure, the terminal device may determine the candidate uplink transmission beam based on the candidate downlink reception beam.

Subsequently, the terminal device may perform the CG-SDT and/or perform the CG-SDT retransmission by using the candidate uplink transmission beam on the dedicated PUSCH resource and may transmit a small data packet.

For the process of performing the CG-SDT and/or performing the CG-SDT retransmission by the terminal device, reference may be made to the above related descriptions, and the same content will not be described again here.

It is understood that when a terminal device does not support the beam correspondence in the CG-SDT procedure, the terminal device needs to perform uplink beam scanning to determine a better or best candidate uplink transmission beam, and performs the CG-SDT by using the determined candidate uplink transmission beam to transmit small data packets.

However, in the embodiments of the present disclosure, the terminal device supports the beam correspondence in the CG-SDT procedure, may determine the candidate uplink transmission beam based on the candidate downlink reception beam used by the network-side device to transmit the RRC release message, and then performs the CG-SDT by using the candidate uplink transmission beam to transmit the small data packet. Therefore, the terminal device does not need to perform uplink beam scanning to determine the uplink beam, which can save energy consumption of the terminal device. Moreover, the terminal device does not need to perform beam scanning to determine the candidate uplink transmission beam, which can reduce delay.

In some embodiments, the terminal device in the non-connected state receives a data reception success indication transmitted by the network-side device, where the data reception success indication is used to indicate that the network-side device has received data transmitted by the terminal device in the CG-SDT procedure and/or in a CG-SDT retransmission procedure.

In the embodiments of the present disclosure, the terminal device performs the CG-SDT and/or performs the CG-SDT retransmission on the dedicated PUSCH resource by using the candidate uplink transmission beam, and transmits data to the network-side device, that is, transmitting a small data packet. After receiving the data transmitted by the terminal device, that is, receiving the small data packet transmitted by the terminal device, the network-side device may transmit the data reception success indication to the terminal device, to inform the terminal device that it has received the data transmitted by the terminal device by performing the CG-SDT and/or performing CG-SDT retransmission.

It may be understood that the CG-SDT includes two phases: an initial data transmission phase and a subsequent data transmission phase.

In the initial data transmission phase, the terminal device in the non-connected state performs the CG-SDT and/or performs the CG-SDT retransmission on the dedicated PUSCH resource by using the candidate uplink transmission beam, and transmits the data (small data packet) to the network-side device.

After receiving the data (small data packet) transmitted by the terminal device during the CG-SDT and/or the CG-SDT retransmission, the network-side device may transmit the data reception success indication to the terminal device.

When the terminal device is in the connected state, the network-side device has learned that the terminal device supports the beam correspondence in the CG-SDT procedure, and there is an association relationship between an SSB beam and a PUSCH resource. The network-side device may determine a downlink beam according to the association relationship between the SSB beam and the PUSCH resource, and a dedicated PUSCH resource used by the terminal device when performing the CG-SDT and/or the CG-SDT retransmission, and then may transmit the data reception success indication to the terminal device on the downlink beam.

The subsequent data transmission phase may be after the terminal device receives the data reception success indication transmitted by the network-side device, and before receiving a connection release message transmitted by the network-side device. In the subsequent data transmission phase, the terminal device may persistently monitor the PDCCH.

In some embodiments, there is a mapping relationship between an SSB beam and a PUSCH resource; and after receiving the data reception success indication transmitted by the network-side device, and before receiving a connection release message transmitted by the network-side device, the method further includes: monitoring a physical downlink control channel (PDCCH), and receiving a PDCCH carrying a cell radio network temporary identifier (C-RNTI) on a candidate SSB beam, where the candidate SSB beam is determined by the network-side device according to the dedicated PUSCH resource and the mapping relationship in response to the terminal device being determined to support the beam correspondence.

It may be understood that, in the subsequent data transmission phase, after the terminal device receives the data reception success indication transmitted by the network-side device and before receiving the connection release message transmitted by the network-side device, the terminal device may monitor the physical downlink control channel (PDCCH), and may receive the PDCCH carrying the C-RNTI on the candidate SSB beam.

There is a mapping relationship between SSBs and PUSCH resources. When the terminal device is in the connected state, the network-side device has learned that the terminal device supports the beam correspondence in the CG-SDT procedure. In the subsequent data transmission phase, the network-side device may determine a corresponding candidate SSB beam according to the mapping relationship and a dedicated PUSCH resource used by the terminal device when performing the CG-SDT and/or the CG-SDT retransmission, and transmits the PDCCH carrying the C-RNTI to the terminal device on the candidate SSB beam.

On the basis of this, the terminal device monitors the PDCCH and may receive the PDCCH carrying the C-RNTI on the candidate SSB beam, so as to further transmit a PUSCH to the network-side device.

In some embodiments, the terminal device determines an uplink SSB beam according to the candidate SSB beam; and transmits a PUSCH to the network-side device on the uplink SSB beam.

In the embodiments of the present disclosure, the terminal device supports the beam correspondence in the CG-SDT procedure, the terminal device monitors the PDCCH, receives the PDCCH carrying the C-RNTI on the candidate SSB beam, and determine the uplink SSB beam according to the candidate SSB beam, and may further transmit the PUSCH to the network-side device on the uplink SSB beam.

It may be understood that when a terminal device does not support the beam correspondence, the terminal device needs to perform uplink beam scanning to determine a beam with better or best beam quality as an uplink transmission beam, and then transmits the PUSCH by using the uplink transmission beam.

In the embodiments of the present disclosure, the terminal device supports the beam correspondence in the CG-SDT procedure, and after receiving the PDCCH on the candidate SSB beam, the terminal device may directly determine the uplink SSB beam according to the candidate SSB beam. The terminal device does not need to perform uplink beam scanning, and can directly determine the uplink SSB beam, which can save energy consumption of the terminal device and reduce latency.

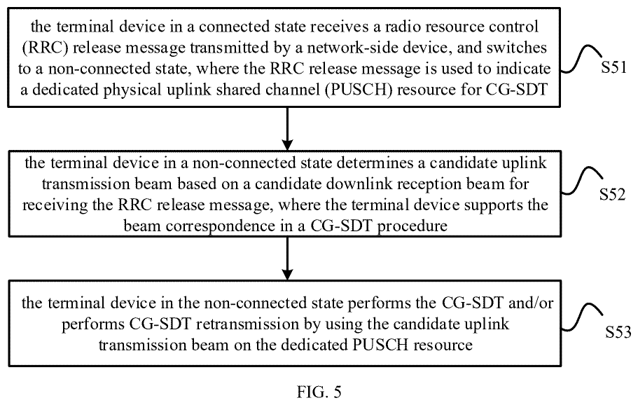

Referring to FIG. 5, FIG. 5 is a flow chart of a capability reporting system provided by an embodiment of the present disclosure.

As shown in FIG. 5, the method is performed by a terminal device. The method may include, but not limited to, the following steps.

In step S51, the terminal device in a connected state receives a radio resource control (RRC) release message transmitted by a network-side device, and switches to a non-connected state, where the RRC release message is used to indicate a dedicated physical uplink shared channel (PUSCH) resource for CG-SDT.

In step S52, the terminal device in a non-connected state determines a candidate uplink transmission beam based on a candidate downlink reception beam for receiving the RRC release message, where the terminal device supports the beam correspondence in a CG-SDT procedure.

In step S53, the terminal device in the non-connected state performs the CG-SDT and/or performs CG-SDT retransmission by using the candidate uplink transmission beam on the dedicated PUSCH resource.

In the embodiments of the present disclosure, the terminal device in the connected state receives an RRC connection release message transmitted by the network-side device and switches to the non-connected state. When the network-side device transmits the RRC connection release message to the terminal device in the connected state, QCL information may be released synchronously.

The RRC connection release message transmitted by the network-side device to the terminal device in the connected state is used to indicate the dedicated PUSCH resource for CG-SDT.

In the embodiment of the present disclosure, after the terminal device in the connected state receives the RRC connection release message transmitted by the network-side device, the terminal device switches from the connected state to the non-connected state. The terminal device in the non-connected state may determine the candidate downlink reception beam for receiving the RRC release message. Since the terminal device supports the beam correspondence in the CG-SDT procedure, the terminal device may determine the candidate uplink transmission beam based on the candidate downlink reception beam.

Subsequently, the terminal device may perform the CG-SDT and/or perform the CG-SDT retransmission by using the candidate uplink transmission beam on the dedicated PUSCH resource to transmit a small data packet.

For the process that the terminal device performs the CG-SDT and/or performs the CG-SDT retransmission, reference can be made to the above related descriptions, and the same content will not be described again here.

It may be understood that when the terminal device does not support the beam correspondence in the CG-SDT procedure, the terminal device needs to perform uplink beam scanning to determine a better or best candidate uplink transmission beam, and uses the determined candidate uplink transmission beam to perform the CG-SDT and transmit a small data packet.

In the embodiments of the present disclosure, the terminal device supports the beam correspondence in the CG-SDT procedure, and can determine the candidate uplink transmission beam based on the candidate downlink reception beam used by the network-side device to transmit the RRC release message, and then use the candidate uplink transmission beam to perform the CG-SDT and transmit a small data packet. Therefore, the terminal device does not need to perform uplink beam scanning to determine an uplink beam, which can save energy consumption of the terminal device. Moreover, the terminal device does not need to perform beam scanning to determine the candidate uplink transmission beam, which can reduce delay.

It should be noted that in the embodiments of the present disclosure, steps S51 to S53 may be implemented alone or in combination with any other steps in the embodiments of the present disclosure, for example, they are implemented together in conjunction with step S41 in the embodiment of the present disclosure, which are not limited by the embodiments of the present disclosure.

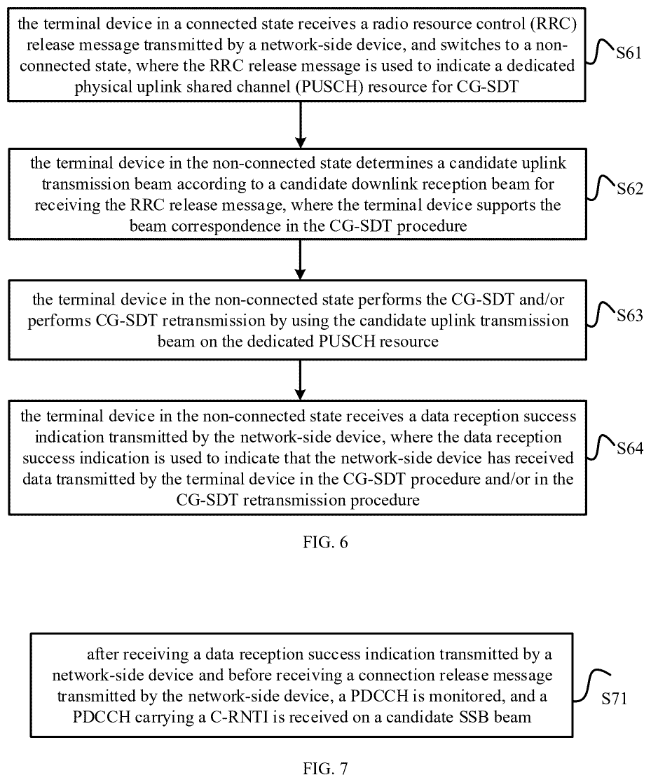

Referring to FIG. 6, FIG. 6 is a flow chart of another capability reporting system provided by an embodiment of the present disclosure.

As shown in FIG. 6, the method is performed by a terminal device. The method may include, but not limited to, the following steps.

In step S61, the terminal device in a connected state receives a radio resource control (RRC) release message transmitted by a network-side device, and switches to a non-connected state, where the RRC release message is used to indicate a dedicated physical uplink shared channel (PUSCH) resource for CG-SDT.

In step S62, the terminal device in the non-connected state determines a candidate uplink transmission beam according to a candidate downlink reception beam for receiving the RRC release message, where the terminal device supports the beam correspondence in the CG-SDT procedure.

In step S63, the terminal device in the non-connected state performs the CG-SDT and/or performs CG-SDT retransmission by using the candidate uplink transmission beam on the dedicated PUSCH resource.

For the relevant descriptions of steps S61 to S63, reference can be made to the relevant descriptions in the above embodiments, which will not be described again here.

In step S64, the terminal device in the non-connected state receives a data reception success indication transmitted by the network-side device, where the data reception success indication is used to indicate that the network-side device has received data transmitted by the terminal device in the CG-SDT procedure and/or in the CG-SDT retransmission procedure.

In the embodiments of the present disclosure, the terminal device performs the CG-SDT and/or performs the CG-SDT retransmission by using the candidate uplink transmission beam on the dedicated PUSCH resource to transmit data to the network-side device, that is, to transmit a small data packet. After receiving the data transmitted by the terminal device, that is, receiving the small data packet transmitted by the terminal device, the network-side device may transmit the data reception success indication to the terminal device to inform the terminal device that the data transmitted by the terminal device in performing the CG-SDT and/or performing the CG-SDT retransmission has been received.

It should be noted that in the embodiment of the present disclosure, steps S61 to S64 may be implemented alone or in combination with any other steps in the embodiment of the present disclosure, for example, they may be implemented in conjunction with step S41 in the embodiment of the present disclosure, which are not limited by the embodiments of the present disclosure.

Referring to FIG. 7, FIG. 7 is a flow chart of another capability reporting system provided by an embodiment of the present disclosure.

As shown in FIG. 7, the method is performed by a terminal device. The method may include, but not limited to, the following steps.

In step S71, after receiving a data reception success indication transmitted by a network-side device and before receiving a connection release message transmitted by the network-side device, a physical downlink control channel (PDCCH) is monitored, and a PDCCH carrying a cell radio network temporary identifier (C-RNTI) is received on a candidate SSB beam, where the candidate SSB beam is determined by the network-side device according to a dedicated PUSCH resource and the mapping relationship in response to the terminal device being determined to support the beam correspondence. There is a mapping relationship between a synchronization signal block (SSB) beam and a PUSCH resource.

It may be understood that the CG-SDT includes two phases: an initial data transmission phase and a subsequent data transmission phase.

The initial data transmission phase includes that: the terminal device in the non-connected state performs the CG-SDT and/or performs the CG-SDT retransmission by using the candidate uplink transmission beam on the dedicated PUSCH resource, and transmits data (small data packet) to the network-side device, and after receiving the data (small data packet) transmitted by the terminal device in the CG-SDT and/or the CG-SDT retransmission, the network-side device may transmit the data reception success indication to the terminal device.

When the terminal device is in the connected state, the network-side device has learned that the terminal device supports the beam correspondence in the CG-SDT procedure, and there is an association relationship between an SSB beam and a PUSCH. The network-side device may determine a downlink beam according to the association relationship between the SSB beam and the PUSCH resource, and a dedicated PUSCH resource used by the terminal device when performing the CG-SDT and/or the CG-SDT retransmission, and then may transmit the data reception success indication to the terminal device on the downlink beam.

The subsequent data transmission phase may be after the terminal device receives the data reception success indication transmitted by the network-side device, and before receiving a connection release message transmitted by the network-side device. In the subsequent data transmission phase, the terminal device may persistently monitor the PDCCH.

It may be understood that, after the terminal device receives the data reception success indication transmitted by the network-side device and before receiving the connection release message transmitted by the network-side device, the terminal device may monitor the physical downlink control channel (PDCCH) in the subsequent data transmission phase, and may receive the PDCCH carrying the C-RNTI on the candidate SSB beam.

There is a mapping relationship between SSBs and PUSCH resources. When the terminal device is in the connected state, the network-side device has learned that the terminal device supports the beam correspondence in the CG-SDT procedure. In the subsequent data transmission phase, the network-side device may determine a corresponding candidate SSB beam according to the mapping relationship and a dedicated PUSCH resource used by the terminal device when performing the CG-SDT and/or the CG-SDT retransmission, and transmits the PDCCH carrying the C-RNTI to the terminal device on the candidate SSB beam.

On the basis of this, the terminal device monitors the PDCCH and may receive the PDCCH carrying the C-RNTI on the candidate SSB beam, so as to further transmit a PUSCH to the network-side device.

It should be noted that in the embodiments of the present disclosure, step S71 may be implemented alone or in combination with any other step in the embodiments of the present disclosure, for example, they are implemented together in conjunction with step S41, and/or steps S51 to S53, and/or steps S61 to S64 in the embodiment of the present disclosure, which are not limited by the embodiments of the present disclosure.

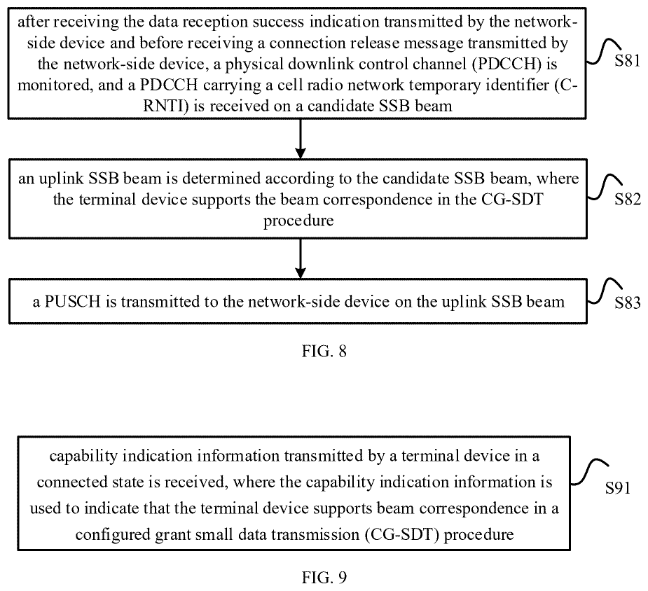

Referring to FIG. 8, FIG. 8 is a flow chart of another capability reporting system provided by an embodiment of the present disclosure.

As shown in FIG. 8, the method is performed by a terminal device. The method may include, but not limited to, the following steps.

In step S81, after receiving the data reception success indication transmitted by the network-side device and before receiving a connection release message transmitted by the network-side device, a physical downlink control channel (PDCCH) is monitored, and a PDCCH carrying a cell radio network temporary identifier (C-RNTI) is received on a candidate SSB beam, where the candidate SSB beam is determined by the network-side device according to the dedicated PUSCH resource and the mapping relationship in response to the terminal device being determined to support the beam correspondence. There is a mapping relationship between a synchronization signal block (SSB) beam and a PUSCH resource.

For the relevant description of step S81, reference can be made to the relevant descriptions in the above embodiments, which will not be described again here.

In step S82, an uplink SSB beam is determined according to the candidate SSB beam, where the terminal device supports the beam correspondence in the CG-SDT procedure.

In step S83, a PUSCH is transmitted to the network-side device on the uplink SSB beam.

In the embodiments of the present disclosure, the terminal device supports the beam correspondence in the CG-SDT procedure, the terminal device monitors the PDCCH, receives the PDCCH carrying the C-RNTI on the candidate SSB beam, can determine the uplink SSB beam according to the candidate SSB beam, and can further transmit the PUSCH to the network-side device on the uplink SSB beam.

The network-side device may determine one or more candidate SSB beams based on the dedicated PUSCH resource and the mapping relationship, and the network-side device may transmit the PDCCH carrying the C-RNTI to the terminal device on multiple candidate SSB beams. The terminal device monitors the PDCCH and receives the PDCCH carrying the C-RNTI on the candidate SSB beam. Since the terminal device supports the beam correspondence, the terminal device may determine the uplink SSB beam according to the candidate SSB beam.

In a case where there is one candidate SSB beam, the terminal device may determine one uplink SSB beam to transmit the PUSCH to the network-side device on the uplink SSB beam. In a case where there are multiple candidate SSB beams, the terminal device may determine multiple uplink beams corresponding to the multiple candidate SSB beams, the terminal device may randomly select one as the uplink SSB beam, or the terminal device may select one as the uplink SSB beam by comparing the multiple uplink beams. The terminal device may compare multiple uplink beams by using a method in related technologies, which is not specifically limited in the embodiments of the present disclosure.

Of course, in a case where there are multiple candidate SSB beams, the terminal device may also determine that uplink beams corresponding to the multiple candidate SSB beams are the uplink SSB beams, and the terminal device may transmit the PUSCH to the terminal device on the multiple uplink SSB beams, which is not specifically limited in the embodiments of the present disclosure.

It may be understood that when the terminal device does not support the beam correspondence, the terminal device needs to perform uplink beam scanning to determine a beam with better or best beam quality as an uplink transmission beam, and then transmits the PUSCH by using the uplink transmission beam.

In the embodiments of the present disclosure, the terminal device supports the beam correspondence in the CG-SDT procedure, and after receiving the PDCCH on the candidate SSB beam, the terminal device may directly determine the uplink SSB beam according to the candidate SSB beam. The terminal device does not need to perform uplink beam scanning, and can directly determine the uplink SSB beam, which can save energy consumption of the terminal device and reduce latency.

It should be noted that in the embodiments of the present disclosure, steps S81 to S83 may be implemented alone or in combination with any other steps in the embodiments of the present disclosure, for example, they may be implemented in combination with step S41, and/or steps S51 to S53, and/or steps S61 to S64 in the embodiments of the present disclosure, which is not limited by the embodiments of the present disclosure.

Referring to FIG. 9, FIG. 9 is a flow chart of another capability reporting method provided by an embodiment of the present disclosure.

As shown in FIG. 9, the method is performed by a network-side device. The method may include, but not limited to, the following steps.

In step S91, capability indication information transmitted by a terminal device in a connected state is received, where the capability indication information is used to indicate that the terminal device supports beam correspondence in a configured grant small data transmission (CG-SDT) procedure.

This is to address the problem in related technologies that the terminal device is not supported to report a capability of supporting the beam correspondence in the CG-SDT procedure.

In the embodiment of the present disclosure, the terminal device in the connected state may transmit the capability indication information to the network-side device, where the capability indication information is used to instruct the terminal device to support beam correspondence in the CG-SDT procedure. In this way, the terminal device can be supported to report to the network-side device that the terminal device has the capability to support the beam correspondence in the CG-SDT procedure.

The terminal device may transmit an information field (IE) of beamcorrespondence-cg-SDT-r18 ENUMERATED {supported} to the network-side device to transmit the capability indication information to the network-side device, so as to report the capability of the terminal device to support the beam correspondence in the CG-SDT procedure.

In some embodiments, the terminal device supporting the beam correspondence refers to that the terminal device may determine an uplink transmission beam based on a downlink reception beam without performing uplink beam scanning.

It is understood that when a terminal device does not support the beam correspondence, the terminal device needs to perform uplink beam scanning to determine a beam with better or best beam quality as the uplink transmission beam, and then performs the CG-SDT by using the uplink transmission beam to transmit a small data packet to the network-side device.

However, in the embodiment of the present disclosure, the terminal device supports the beam correspondence in the CG-SDT procedure, and the terminal device may determine the uplink transmission beam according to the downlink reception beam used by a dedicated PUSCH resource configured by the network-side device, and may transmit the small data packet to the network-side device on the dedicated PUSCH resource by using the determined uplink transmission beam, to perform the CG-SDT and/or perform CG-SDT retransmission.

In some embodiments, the network-side device transmits an RRC release message to the terminal device in the connected state and releases QCL information, where the RRC release message is used to indicate a dedicated PUSCH resource for CG-SDT; receives data transmitted by the terminal device in a non-connected state by performing the CG-SDT and/or performing CG-SDT retransmission on the dedicated PUSCH resource by using a candidate uplink transmission beam, where the candidate uplink transmission beam is determined by the terminal device according to a candidate downlink reception beam for receiving the RRC release message.

In the embodiment of the present disclosure, the terminal device in the connected state receives the RRC connection release message transmitted by the network-side device and switches to the non-connected state. The network-side device transmits the RRC connection release message to the terminal device in the connected state, and QCL information may be released synchronously.

The RRC connection release message transmitted by the network-side device to the terminal device in the connected state is used to indicate the dedicated PUSCH resource for CG-SDT.

In the embodiments of the present disclosure, after the terminal device in the connected state receives the RRC connection release message transmitted by the network-side device, the terminal device switches from the connected state to the non-connected state. The terminal device in the non-connected state may determine the candidate downlink reception beam for receiving the RRC release message. Since the terminal device supports the beam correspondence in the CG-SDT procedure, the terminal device may determine the candidate uplink transmission beam based on the candidate downlink reception beam.

Subsequently, the terminal device may perform the CG-SDT and/or perform the CG-SDT retransmission by using the candidate uplink transmission beam on the dedicated PUSCH resource and may transmit a small data packet.

For the process of performing the CG-SDT and/or performing the CG-SDT retransmission by the terminal device, reference may be made to the above related descriptions, and the same content will not be described again here.

It is understood that when a terminal device does not support the beam correspondence in the CG-SDT procedure, the terminal device needs to perform uplink beam scanning to determine a better or best candidate uplink transmission beam, and performs the CG-SDT by using the determined candidate uplink transmission beam to transmit small data packets.

However, in the embodiments of the present disclosure, the terminal device supports the beam correspondence in the CG-SDT procedure, and may determine the candidate uplink transmission beam based on the candidate downlink reception beam used by the network-side device to transmit the RRC release message, and then performs the CG-SDT by using the candidate uplink transmission beam to transmit the small data packet. Therefore, the terminal device does not need to perform uplink beam scanning to determine the uplink beam, which can save energy consumption of the terminal device. Moreover, the terminal device does not need to perform beam scanning to determine the candidate uplink transmission beam, which can reduce delay.

In some embodiments, the network-side device transmits a data reception success indication to the terminal device in the non-connected state, where the data reception success indication is used to indicate that the network-side device has received the data transmitted by the terminal device in the CG-SDT procedure and/or in a CG-SDT retransmission procedure.

In the embodiments of the present disclosure, the terminal device performs the CG-SDT and/or performs the CG-SDT retransmission on the dedicated PUSCH resource by using the candidate uplink transmission beam, and transmits data to the network-side device, that is, transmitting a small data packet. After receiving the data transmitted by the terminal device, that is, receiving the small data packet transmitted by the terminal device, the network-side device may transmit the data reception success indication to the terminal device, to inform the terminal device that it has received the data transmitted by the terminal device by performing the CG-SDT and/or performing CG-SDT retransmission.

It may be understood that CG-SDT includes two phases: an initial data transmission phase and a subsequent data transmission phase.

In the initial data transmission phase, the terminal device in the non-connected state performs the CG-SDT and/or performs the CG-SDT retransmission on the dedicated PUSCH resource by using the candidate uplink transmission beam, and transmits the data (small data packet) to the network-side device.

After receiving the data (small data packet) transmitted by the terminal device in the CG-SDT and/or the CG-SDT retransmission, the network-side device may transmit the data reception success indication to the terminal device.

When the terminal device is in the connected state, the network-side device has learned that the terminal device supports the beam correspondence in the CG-SDT procedure, and there is an association relationship between SSB beams and PUSCHs. The network-side device may determine a downlink beam according to the association relationship between the SSB beam and the PUSCH resource, and a dedicated PUSCH resource used by the terminal device when performing the CG-SDT and/or the CG-SDT retransmission, and then may transmit the data reception success indication to the terminal device on the downlink beam.

The subsequent data transmission phase may be after the terminal device receives the data reception success indication transmitted by the network-side device, and before receiving a connection release message transmitted by the network-side device. In the subsequent data transmission phase, the terminal device may persistently monitor the PDCCH.

In some embodiments, there is a mapping relationship between a synchronization signal block (SSB) beam and a PUSCH resource; and after transmitting the data reception success indication to the terminal device, and before transmitting a connection release message to the terminal device, the method further includes: determining that the terminal device supports the beam correspondence, and determining a candidate SSB beam according to the dedicated PUSCH resource and the mapping relationship; and transmitting a PDCCH carrying a C-RNTI to the terminal device on the candidate SSB beam.

It may be understood that, in the subsequent data transmission phase, after the terminal device receives the data reception success indication transmitted by the network-side device and before receiving the connection release message transmitted by the network-side device, the terminal device may monitor the physical downlink control channel (PDCCH), and may receive the PDCCH carrying the C-RNTI on the candidate SSB beam.

There is a mapping relationship between SSBs and PUSCH resources. When the terminal device is in the connected state, the network-side device has learned that the terminal device supports the beam correspondence in the CG-SDT procedure. In the subsequent data transmission phase, the network-side device may determine a corresponding candidate SSB beam according to the mapping relationship and a dedicated PUSCH resource used by the terminal device when performing the CG-SDT and/or the CG-SDT retransmission, and transmits the PDCCH carrying the C-RNTI to the terminal device on the candidate SSB beam.

On the basis of this, the terminal device monitors the PDCCH and may receive the PDCCH carrying the C-RNTI on the candidate SSB beam, so as to further transmit a PUSCH to the network-side device.

In some embodiments, the network-side device receives a PUSCH transmitted by the terminal device in the non-connected state on an uplink SSB beam, where the uplink SSB beam is determined by the terminal device according to the candidate SSB beam.

In the embodiments of the present disclosure, the terminal device supports the beam correspondence in the CG-SDT procedure, the terminal device monitors the PDCCH, receives the PDCCH carrying the C-RNTI on the candidate SSB beam, may determine the uplink SSB beam according to the candidate SSB beam, and may further transmit the PUSCH to the network-side device on the uplink SSB beam.

It may be understood that when a terminal device does not support the beam correspondence, the terminal device needs to perform uplink beam scanning to determine a beam with better or best beam quality as an uplink transmission beam, and then transmits the PUSCH by using the uplink transmission beam.

In the embodiments of the present disclosure, the terminal device supports the beam correspondence in the CG-SDT procedure, and after receiving the PDCCH on the candidate SSB beam, the terminal device may directly determine the uplink SSB beam according to the candidate SSB beam. The terminal device does not need to perform uplink beam scanning, and can directly determine the uplink SSB beam, which can save energy consumption of the terminal device and reduce latency.

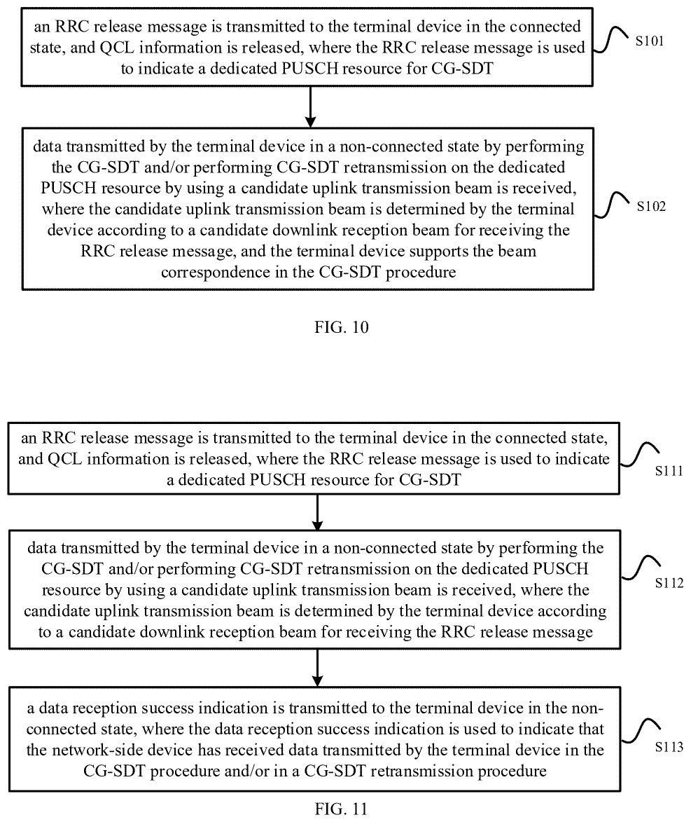

Referring to FIG. 10, FIG. 10 is a flow chart of another capability reporting system provided by an embodiment of the present disclosure.

As shown in FIG. 10, the method is performed by a network-side device. The method may include, but not limited to, the following steps.

In step S101, an RRC release message is transmitted to the terminal device in the connected state, and QCL information is released, where the RRC release message is used to indicate a dedicated PUSCH resource for CG-SDT.

In step S102, data transmitted by the terminal device in a non-connected state by performing the CG-SDT and/or performing CG-SDT retransmission on the dedicated PUSCH resource by using a candidate uplink transmission beam is received, where the candidate uplink transmission beam is determined by the terminal device according to a candidate downlink reception beam for receiving the RRC release message, and the terminal device supports the beam correspondence in the CG-SDT procedure.

In the embodiment of the present disclosure, the terminal device in the connected state receives the RRC connection release message transmitted by the network-side device, and switches to the non-connected state. The network-side device transmits the RRC connection release message to the terminal device in the connected state, and QCL information may be released synchronously.

The RRC connection release message transmitted by the network-side device to the terminal device in the connected state is used to indicate the dedicated PUSCH resource for CG-SDT.

In the embodiments of the present disclosure, after the terminal device in the connected state receives the RRC connection release message transmitted by the network-side device, the terminal device switches from the connected state to the non-connected state. The terminal device in the non-connected state may determine the candidate downlink reception beam for receiving the RRC release message. Since the terminal device supports the beam correspondence in the CG-SDT procedure, the terminal device may determine the candidate uplink transmission beam based on the candidate downlink reception beam.

Subsequently, the terminal device may perform the CG-SDT and/or perform the CG-SDT retransmission by using the candidate uplink transmission beam on the dedicated PUSCH resource and may transmit a small data packet.

For the process of performing the CG-SDT and/or performing the CG-SDT retransmission by the terminal device, reference may be made to the above related descriptions, and the same content will not be described again here.

It is understood that when a terminal device does not support the beam correspondence in the CG-SDT procedure, the terminal device needs to perform uplink beam scanning to determine a better or best candidate uplink transmission beam, and performs the CG-SDT by using the determined candidate uplink transmission beam to transmit small data packets.

However, in the embodiments of the present disclosure, the terminal device supports the beam correspondence in the CG-SDT procedure, may determine the candidate uplink transmission beam based on the candidate downlink reception beam used by the network-side device to transmit the RRC release message, and then performs the CG-SDT by using the candidate uplink transmission beam to transmit the small data packet. Therefore, the terminal device does not need to perform uplink beam scanning to determine the uplink beam, which can save energy consumption of the terminal device. Moreover, the terminal device does not need to perform beam scanning to determine the candidate uplink transmission beam, which can reduce delay.

It should be noted that in the embodiments of the present disclosure, steps S101 and S102 may be implemented alone or in combination with any other steps in the embodiments of the present disclosure, for example, they may be implemented in conjunction with step S91 in the embodiment of the present disclosure, which are not limited by the embodiments of the present disclosure.

Referring to FIG. 11, FIG. 11 is a flow chart of another capability reporting system provided by an embodiment of the present disclosure.

As shown in FIG. 11, the method is performed by a network-side device. The method may include, but not limited to, the following steps.

In step S111, an RRC release message is transmitted to the terminal device in the connected state, and QCL information is released, where the RRC release message is used to indicate a dedicated PUSCH resource for CG-SDT.

In step S112, data transmitted by the terminal device in a non-connected state by performing the CG-SDT and/or performing CG-SDT retransmission on the dedicated PUSCH resource by using a candidate uplink transmission beam is received, where the candidate uplink transmission beam is determined by the terminal device according to a candidate downlink reception beam for receiving the RRC release message.

For relevant descriptions of steps S111 and S112, reference can be made to the relevant descriptions in the above embodiments, which will not be described again here.

In step S113, a data reception success indication is transmitted to the terminal device in the non-connected state, where the data reception success indication is used to indicate that the network-side device has received data transmitted by the terminal device in the CG-SDT procedure and/or in a CG-SDT retransmission procedure.

In the embodiments of the present disclosure, the terminal device performs the CG-SDT and/or performs the CG-SDT retransmission on the dedicated PUSCH resource by using the candidate uplink transmission beam, and transmits data to the network-side device, that is, transmitting a small data packet. After receiving the data transmitted by the terminal device, that is, receiving the small data packet transmitted by the terminal device, the network-side device may transmit the data reception success indication to the terminal device, to inform the terminal device that the network-side device has received the data transmitted by the terminal device in performing the CG-SDT and/or performing CG-SDT retransmission.

It should be noted that in the embodiments of the present disclosure, steps S111 to S113 may be implemented alone or in combination with any other steps in the embodiments of the present disclosure, for example, they are implemented together in combination with step S91 in the embodiment of the present disclosure, which are not limited by the embodiments of the present disclosure.

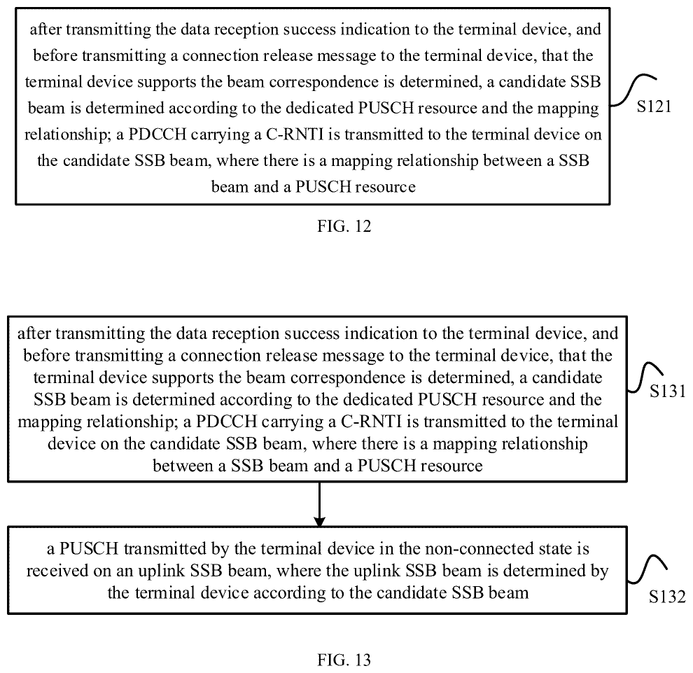

Referring to FIG. 12, FIG. 12 is a flow chart of another capability reporting system provided by an embodiment of the present disclosure.

As shown in FIG. 12, the method is performed by a network-side device. The method may include, but not limited to, the following steps.

In step S121, after transmitting the data reception success indication to the terminal device, and before transmitting a connection release message to the terminal device, that the terminal device supports the beam correspondence is determined, a candidate SSB beam is determined according to the dedicated PUSCH resource and the mapping relationship; a PDCCH carrying a C-RNTI is transmitted to the terminal device on the candidate SSB beam, where there is a mapping relationship between a synchronization signal block (SSB) beam and a PUSCH resource.

It may be understood that CG-SDT includes two phases: an initial data transmission phase and a subsequent data transmission phase.

In the initial data transmission phase, the terminal device in the non-connected state performs the CG-SDT and/or performs the CG-SDT retransmission on the dedicated PUSCH resource by using the candidate uplink transmission beam, and transmits the data (small data packet) to the network-side device. After receiving the data (small data packet) transmitted by the terminal device during the CG-SDT and/or the CG-SDT retransmission, the network-side device may transmit the data reception success indication to the terminal device.

When the terminal device is in the connected state, the network-side device has learned that the terminal device supports the beam correspondence in the CG-SDT procedure, and there is an association relationship between an SSB beam and a PUSCH. The network-side device may determine a downlink beam according to the association relationship between the SSB beam and the PUSCH resource, and a dedicated PUSCH resource used by the terminal device when performing the CG-SDT and/or the CG-SDT retransmission, and then may transmit the data reception success indication to the terminal device on the downlink beam.

The subsequent data transmission phase may be after the terminal device receives the data reception success indication transmitted by the network-side device, and before receiving a connection release message transmitted by the network-side device. In the subsequent data transmission phase, the terminal device may persistently monitor the PDCCH.

It may be understood that, in the subsequent data transmission phase, after the terminal device receives the data reception success indication transmitted by the network-side device and before receiving the connection release message transmitted by the network-side device, the terminal device may monitor the physical downlink control channel (PDCCH), and may receive the PDCCH carrying the C-RNTI on the candidate SSB beam.

There is a mapping relationship between SSBs and PUSCH resources. When the terminal device is in the connected state, the network-side device has learned that the terminal device supports the beam correspondence in the CG-SDT procedure. In the subsequent data transmission phase, the network-side device may determine a corresponding candidate SSB beam according to the mapping relationship and a dedicated PUSCH resource used by the terminal device when performing the CG-SDT and/or the CG-SDT retransmission, and transmits the PDCCH carrying the C-RNTI to the terminal device on the candidate SSB beam.

On the basis of this, the terminal device monitors the PDCCH and may receive the PDCCH carrying the C-RNTI on the candidate SSB beam, so as to further transmit a PUSCH to the network-side device.

It should be noted that in the embodiments of the present disclosure, step S121 may be implemented alone or in combination with any other steps in the embodiment of the present disclosure, for example, they are implemented together in conjunction with step S91, and/or steps S101 and S102, and/or steps S111 to S113 in the embodiments of the present disclosure, which are not limited by the embodiments of the present disclosure.

Referring to FIG. 13, FIG. 13 is a flow chart of another capability reporting system provided by an embodiment of the present disclosure.

As shown in FIG. 13, the method is performed by a network-side device. The method may include, but not limited to, the following steps.

In step S131, after transmitting the data reception success indication to the terminal device, and before transmitting a connection release message to the terminal device, that the terminal device supports the beam correspondence is determined, a candidate SSB beam is determined according to the dedicated PUSCH resource and the mapping relationship; a PDCCH carrying a C-RNTI is transmitted to the terminal device on the candidate SSB beam, where there is a mapping relationship between a synchronization signal block (SSB) beam and a PUSCH resource.

For the relevant description of step S131, reference can be made to the relevant descriptions in the above embodiments, which will not be described again here.

In step S132, a PUSCH transmitted by the terminal device in the non-connected state is received on an uplink SSB beam, where the uplink SSB beam is determined by the terminal device according to the candidate SSB beam.

In the embodiments of the present disclosure, the terminal device supports the beam correspondence in the CG-SDT procedure, the terminal device monitors the PDCCH, receives the PDCCH carrying the C-RNTI on the candidate SSB beam, may determine the uplink SSB beam according to the candidate SSB beam, and may further transmit the PUSCH to the network-side device on the uplink SSB beam.

It may be understood that when a terminal device does not support the beam correspondence, the terminal device needs to perform uplink beam scanning to determine a beam with better or best beam quality as an uplink transmission beam, and then transmits the PUSCH by using the uplink transmission beam.

In the embodiments of the present disclosure, the terminal device supports the beam correspondence in the CG-SDT procedure, and after receiving the PDCCH on the candidate SSB beam, the terminal device may directly determine the uplink SSB beam according to the candidate SSB beam. The terminal device does not need to perform uplink beam scanning, and can directly determine the uplink SSB beam, which can save energy consumption of the terminal device and reduce latency.

It should be noted that in the embodiments of the present disclosure, steps S131 and S132 may be implemented alone or in combination with any other steps in the embodiments of the present disclosure, for example, they are implemented together in combination with step S91, and/or steps S101 and S102, and/or steps S111 to S113, which are not limited by the embodiments of the present disclosure In the above embodiments provided by the present disclosure, the methods provided by the embodiments of the present disclosure are introduced from the perspectives of the terminal device and the network-side device, respectively. In order to implement various functions in the method provided by the above embodiments of the present disclosure, the terminal device and the network-side device may include a hardware structure and a software module to implement the above functions in a form of a hardware structure, a software module, or a hardware structure plus a software module. A certain function among the above functions may be executed by a hardware structure, a software module, or a hardware structure plus a software module.

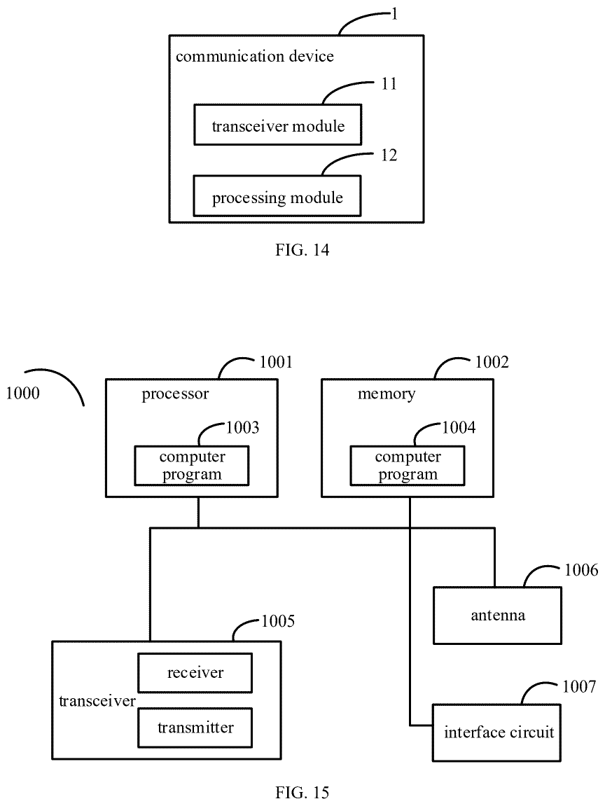

Referring to FIG. 14, FIG. 14 is a schematic structural diagram of a communication device 1 provided by an embodiment of the present disclosure. The communication device 1 shown in FIG. 14 may include a transceiver module 11 and a processing module 12. The transceiver module 11 may include a transmitting module and/or a receiving module. The transmitting module is configured to implement a transmitting function, and the receiving module is configured to implement a receiving function. The transceiver module 11 may implement the transmitting function and/or the receiving function.

The communication device 1 may be a terminal device, a device in the terminal device, or a device that may be used in conjunction with the terminal device. Alternatively, the communication device 1 may be a network-side device, a device in the network-side device, or a device that may be used in conjunction with the network-side device.

The communication device 1 is a terminal device:

The device includes: a transceiver module 11.

The transceiver module 11 is configured to transmit, in a connected state, capability indication information to a network-side device, where the capability indication information is used to indicate that the terminal device supports beam correspondence in a configured grant small data transmission (CG-SDT) procedure.

In some embodiments, the terminal device supporting the beam correspondence refers to that the terminal device may determine an uplink transmission beam based on a downlink reception beam without performing uplink beam scanning.

In some embodiments, the transceiver module 11 is further configured to receive, in a connected state, a radio resource control (RRC) release message transmitted by the network-side device, and switch to a non-connected state, where the RRC release message is used to indicate a dedicated physical uplink shared channel (PUSCH) resource for CG-SDT.

The processing module 12 is configured to determine, in the non-connected state, a candidate uplink transmission beam according to a candidate downlink reception beam for receiving the RRC release message.

The transceiver module 11 is further configured to perform, in the non-connected state, the CG-SDT and/or perform CG-SDT retransmission by using the candidate uplink transmission beam on the dedicated PUSCH resource.

In some embodiments, the transceiver module 11 is further configured to receive for the terminal device in the non-connected state, a data reception success indication transmitted by the network-side device, where the data reception success indication is used to indicate that the network-side device has received data transmitted by the terminal device in the CG-SDT procedure and/or in a CG-SDT retransmission procedure.

In some embodiments, there is a mapping relationship between a synchronization signal block (SSB) beam and a PUSCH resource; and after receiving the data reception success indication transmitted by the network-side device, and before receiving a connection release message transmitted by the network-side device, the transceiver module 11 is further configured to: monitor a physical downlink control channel (PDCCH), and receive a PDCCH carrying a cell radio network temporary identifier (C-RNTI) on a candidate SSB beam, where the candidate SSB beam is determined by the network-side device according to the dedicated PUSCH resource and the mapping relationship in response to the terminal device being determined to support the beam correspondence.

In some embodiments, the processing module 12 is further configured to determine an uplink SSB beam according to the candidate SSB beam.

The transceiver module 11 is further configured to transmit a PUSCH to the network-side device on the uplink SSB beam.

The communication device 1 is a network-side device:

The device includes: a transceiver module 11.

The transceiver module 11 is configured to receive capability indication information transmitted by a terminal device in a connected state, where the capability indication information is used to indicate that the terminal device supports beam correspondence in a configured grant small data transmission (CG-SDT) procedure.

In some embodiments, the terminal device supporting the beam correspondence refers to that the terminal device may determine an uplink transmission beam based on a downlink reception beam without performing uplink beam scanning.

In some embodiments, the transceiver module 11 is further configured to transmit an RRC release message to the terminal device in the connected state, and releasing Quasi-collocation (QCL) information, where the RRC release message is used to indicate a dedicated PUSCH resource for CG-SDT.

The transceiver module 11 is further configured to receive data transmitted by the terminal device in a non-connected state by performing the CG-SDT and/or performing CG-SDT retransmission on the dedicated PUSCH resource by using a candidate uplink transmission beam, where the candidate uplink transmission beam is determined by the terminal device according to a candidate downlink reception beam for receiving the RRC release message.

In some embodiments, the transceiver module 11 is further configured to transmit a data reception success indication to the terminal device in the non-connected state, where the data reception success indication is used to indicate that the network-side device has received the data transmitted by the terminal device in the CG-SDT procedure and/or in a CG-SDT retransmission procedure.

In some embodiments, there is a mapping relationship between a synchronization signal block (SSB) beam and a PUSCH resource; and after transmitting the data reception success indication to the terminal device, and before transmitting a connection release message to the terminal device, the processing module 12 is configured to determine that the terminal device supports the beam correspondence, and determine a candidate SSB beam according to the dedicated PUSCH resource and the mapping relationship, and the transceiver module 11 is further configured to transmit a PDCCH carrying a C-RNTI to the terminal device on the candidate SSB beam.

In some embodiments, the transceiver module 11 is further configured to receive a PUSCH transmitted by the terminal device in the non-connected state on an uplink SSB beam, where the uplink SSB beam is determined by the terminal device according to the candidate SSB beam.

Regarding the devices in the above embodiments, specific manners in which each module performs operations have been described in detail in the embodiments related to the method, and will not be described in detail here.

The communication device 1 provided in the above embodiments of the present disclosure achieves the same or similar beneficial effects as the capability reporting methods provided in some of the above embodiments, and will not be described again here.

Referring to FIG. 15, FIG. 15 is a schematic structural diagram of another communication device 1000 provided by an embodiment of the present disclosure. The communication device 1000 may be a network-side device or a terminal device, or may be a chip, a chip system, or a processor that supports the network-side device to implement the above method, or may be a chip, a chip system, or a processor that supports the terminal device to implement the above method. The communication device 1000 can be used to implement the methods described in the above method embodiments. For details, reference can be made to the description in the above method embodiments.

The communication device 1000 may include one or more processors 1001. The processor 1001 may be a general-purpose processor or a special-purpose processor, or the like. For example, the processor may be a baseband processor or a central processing unit. The baseband processor may be used to process communication protocols and communication data. The central processor may be used to control the communication device (such as a network-side device, a baseband chip, a terminal device, a chip of the terminal device, a DU or a CU, etc.), to execute the computer program, and to process data in the computer program.

In some embodiments, the communication device 1000 may also include one or more memories 1002, on which a computer program 1004 may be stored. The memory 1002 is configured to execute the computer program 1004 to cause the communication device 1000 to perform steps described in the above method embodiments. In some embodiments, the memory 1002 may also store data. The communication device 1000 and the memory 1002 may be arranged separately or integrated together.

In some embodiments, the communication device 1000 may also include a transceiver 1005 and an antenna 1006. The transceiver 1005 may be referred to as a transceiver unit, a transceiver module, a transceiver circuit, etc., and is configured to implement receiving and transmitting functions. The transceiver 1005 may include a receiver and a transmitter. The receiver may be referred to as a receiver unit or a receiver circuit, etc., and configured to implement receiving function; the transmitter may be referred to as a transmitter unit, a transmitter circuit, etc., and configured to implement the transmitting function.

In some embodiments, the communication device 1000 may also include one or more interface circuits 1007. The interface circuit 1007 is configured to receive code instructions and transmit them to the processor 1001. The processor 1001 is configured to execute the code instructions to cause the communication device 1000 to perform the method described in the above method embodiments.

In a case where the communication device 1000 is a terminal device, the transceiver 1005 is configured to perform step S41 in FIG. 4; steps S51 and S53 in FIG. 5; steps S61, S63 and S64 in FIG. 6; step S71 in FIG. 7; and steps S81 and S83 in FIG. 8; the processor 1001 is used to execute step S52 in FIG. 5; step S62 in FIG. 6; and step S82 in FIG. 8.

In a case where the communication device 1000 is a network-side device, the transceiver 1005 is configured to perform step S91 in FIG. 9; steps S101 and S102 in FIG. 10; steps S111 to S113 in FIG. 11; step S121 in FIG. 12; and steps S131 and S132 in FIG. 13.

In an implementation, the processor 1001 may include a transceiver for implementing receiving and transmitting functions. For example, the transceiver may be a transceiver circuit, an interface, or an interface circuit. The transceiver circuit, the interface or the interface circuit for implementing receiving and transmitting functions may be separated from each other or integrated together. The above-mentioned transceiver circuit, interface or interface circuit may be configured to read and write codes/data, or transmit or transfer signals.

In an implementation, the processor 1001 may store a computer program 1003, and the computer program 1003, when executed by the processor 1001, causes the communication device 1000 to perform the method described in the above method embodiments. The computer program 1003 may be solidified in the processor 1001, in which case the processor 1001 may be implemented by hardware.

In an implementation, the communication device 1000 may include a circuit, and the circuit can implement the functions of transmitting, receiving, or communicating in the foregoing method embodiments. The processor and the transceiver described in the present disclosure may be implemented in an integrated circuit (IC), an analog IC, a radio frequency integrated circuit (RFIC), a mixed signal IC, an application specific integrated circuits (ASIC), a printed circuit board ( printed circuit board (PCB), electronic equipment, etc. The processor and the transceiver may be manufactured using various IC process technologies, such as complementary metal oxide semiconductor (CMOS), N-channel Metal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication device described in the above embodiments may be a terminal device, the scope of the communication device described in the present disclosure is not limited thereto, and the structure of the communication device may not be limited by FIG. 15. The communication device may be a stand-alone device or may be a part of a larger device. For example, the communication device may be:
(1) an independent integrated circuit (IC), or chip, or chip system or subsystem;
(2) a collection of one or more ICs, where, in some embodiments, the IC collection may also include a storage component for storing data and a computer program;
(3)ASIC, such as modem;
(4) a module that can be embedded into other devices;
(5) a receiver, a terminal device, an intelligent terminal device, a cellular phone, a wireless equipment, a handheld device, a mobile unit, a vehicle-mounted equipment, a network device, a cloud equipment, an artificial intelligence equipment, etc. ;
(6) other component(s), etc.

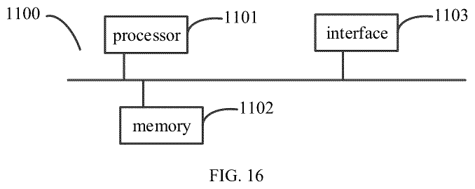

For the case where the communication device may be a chip or a chip system, reference may be made to FIG. 16, which is a structural diagram of a chip provided in an embodiment of the present disclosure.

The chip includes a processor 1101 and an interface 1103. The number of processors 1101 may be one or multiple, and the number of interfaces 1103 may be multiple.

The case where the chip is configured to implement the functions of the network-side device in the embodiment of the present disclosure is as follows.

The interface 1103 is configured to read code instructions and transmit the same to the processor.

The processor 1101 is configured to execute the code instructions to perform the capability reporting method described in some of the above-mentioned embodiments.

The case where the chip is configured to implement the functions of the terminal device in the embodiment of the present disclosure is as follows.

The interface 1103 is configured to read code instructions and transmit the same to the processor.

The processor 1101 is configured to execute the code instructions to perform the capability reporting method described in some of the above-mentioned embodiments.

In some embodiments, the chip 1100 further includes a memory 1102, which is used to store necessary computer programs and data.

Those skilled in the art can also understand that various illustrative logical blocks and steps listed in the embodiments of the present disclosure can be implemented by electronic hardware, computer software, or a combination of both. Whether such functions are implemented in hardware or software depends on the specific application and the overall system design requirement. Those skilled in the art can use various methods to implement the described functions for each specific application, but such implementation should not be understood as exceeding the protection scope of the embodiments of the present disclosure.

An embodiment of the present disclosure further provides a capability reporting system, including the communication device as the terminal device and the communication device as the network-side device in the above embodiments in FIG. 14, or the system includes the communication device as the terminal device and the communication device as a network-side device in the above embodiments in FIG. 15.

The present disclosure further provides a readable storage medium, on which instructions are stored. When the instructions are executed by a computer, functions of any of the above method embodiments are implemented.

The present disclosure further provides a computer program product. The computer program product is executed by a computer to implement functions of any of the above method embodiments.

The above embodiments may be implemented in whole or in part by software, hardware, firmware, or any combination thereof. When implemented by software, it may be implemented in whole or in part in the form of a computer program product. The computer program product includes one or more computer programs. When the computer program is loaded and executed by a computer, the processes or functions described in the embodiments of the present disclosure are generated in whole or in part. The computer may be a general-purpose computer, a special-purpose computer, a computer network, or other programmable device. The computer program may be stored in or transferred from one computer-readable storage medium to another computer-readable storage medium. For example, the computer program may be transferred from a website, a computer, a server, or a data center to another website, computer, server or data center to another website, a computer, a server, or a data center to another website, computer, server or data center through wired means (such as coaxial cable, optical fiber, digital subscriber line (DSL)) or wireless means (such as infrared, wireless, microwave, etc.). The computer-readable storage medium may be any available medium that can be accessed by a computer or a data storage device integrated by one or more available media, which includes a server, a data center, and so on. The available media may be magnetic media (e.g., floppy disk, hard disk, magnetic tape), optical media (e.g., high-density digital video discs (DVD)), or semiconductor media (e.g., solid state disk (SSD)) etc.

Those of ordinary skill in the art may appreciate that numerical numbers such as first and second involved in the present disclosure are only for convenience of description, and are not used to limit the scope of the embodiments of the present disclosure, or to indicate the order.

At least one in the present disclosure may also be described as one or more, and the plurality may be two, three, four or more, which are not limited by the present disclosure. In the embodiments of the present disclosure, technical features are distinguished by terms “first”, “second”, “third”, “A”, “B”, “C”, and “D”, etc. The technical features described by the terms “first”, “second”, “third”, “A”, “B”, “C”and “D”are not in an order of precedence or in an order of size.

The corresponding relationships shown in each table in the present disclosure can be configured or predefined. The values of the information in each table are only examples and can be configured as other values, which is not limited by the present disclosure. When the correspondence between information and each parameter is configured, it is not necessarily required to configure all the correspondences shown in each table. For example, in the table in the present disclosure, the correspondences shown in some rows may not be configured. For another example, appropriate form adjustments can be made based on the above table, such as splitting, merging, etc. The names of the parameters shown in the titles of the above tables may also be other names understandable by the communication apparatus, and the values or expressions of the parameters may also be other values or expressions understandable by the communication apparatus. When implementing the above tables, other data structures can also be used, such as array, queue, container, stack, linear list, pointer, linked list, tree, graph, structure, class, heap, distributed table or hash table.

The term predefined in the present disclosure may be understood as defined, pre-defined, storage, pre-storage, pre-negotiation, pre-configuration, solidification, or pre-burning.

Those of ordinary skill in the art will appreciate that the units and algorithm steps of each example described in conjunction with the embodiments disclosed herein can be implemented with electronic hardware, or a combination of computer software and electronic hardware. Whether these functions are performed in hardware or software depends on the specific application and design constraints of the technical solution. Those of ordinary skill in the art may implement the described functionality using different methods for each specific application, but such implementations should not be considered as exceeding the scope of the present disclosure.

Those of ordinary skill in the art can clearly understand that for the convenience and simplicity of description, reference may be made to the corresponding processes in the foregoing method embodiments for the specific working processes of the systems, devices and units described above, which will not be described again here.

The above are only specific implementations of the present disclosure, but the protection scope of the present disclosure is not limited thereto. Changes or substitutions easily occurring to any person familiar with the technical field can within the technical scope disclosed in the present disclosure shall fall within the protection scope of the present disclosure. Therefore, the protection scope of the present disclosure should be subject to the protection scope of the claims.

1. A capability reporting method, performed by a terminal device, comprising:
transmitting, by the terminal device in a connected state, capability indication information to a network-side device, wherein the capability indication information indicates that the terminal device supports beam correspondence in a configured grant small data transmission (CG-SDT) procedure.

2. The method according to claim 1, further comprising:
receiving, by the terminal device in the connected state, a radio resource control (RRC) release message transmitted by the network-side device, and switching to a non-connected state, wherein the RRC release message indicates a dedicated physical uplink shared channel (PUSCH) resource for CG-SDT;
determining, by the terminal device in the non-connected state, a candidate uplink transmission beam according to a candidate downlink reception beam for receiving the RRC release message; and
performing the CG-SDT and/or performing CG-SDT retransmission, by the terminal device in the non-connected state, by using the candidate uplink transmission beam on the dedicated PUSCH resource.

3. The method according to claim 2, further comprising:
receiving, by the terminal device in the non-connected state, a data reception success indication transmitted by the network-side device, wherein the data reception success indication indicates that the network-side device has received data transmitted by the terminal device in the CG-SDT procedure and/or in a CG-SDT retransmission procedure.

4. The method according to claim 3, wherein there is a mapping relationship between a synchronization signal block (SSB) beam and a PUSCH resource; and after receiving the data reception success indication transmitted by the network-side device, and before receiving the RRC release message transmitted by the network-side device, the method further comprises:
monitoring a physical downlink control channel (PDCCH), and receiving a PDCCH carrying a cell radio network temporary identifier (C-RNTI) on a candidate SSB beam, wherein the candidate SSB beam is determined by the network-side device according to the dedicated PUSCH resource and the mapping relationship in response to the terminal device being determined to support the beam correspondence.

5. The method according to claim 4, further comprising:
determining an uplink SSB beam according to the candidate SSB beam; and
transmitting a PUSCH to the network-side device on the uplink SSB beam.

6. A capability reporting method, performed by a network-side device, comprising:
receiving capability indication information transmitted by a terminal device in a connected state, wherein the capability indication information indicates that the terminal device supports beam correspondence in a configured grant small data transmission (CG-SDT) procedure.

7. The method according to claim 6, further comprising:
transmitting an RRC release message to the terminal device in the connected state, and releasing Quasi-collocation (QCL) information, wherein the RRC release message indicates a dedicated PUSCH resource for CG-SDT; and
receiving data transmitted by the terminal device in a non-connected state by performing the CG-SDT and/or performing CG-SDT retransmission on the dedicated PUSCH resource by using a candidate uplink transmission beam, wherein the candidate uplink transmission beam is determined by the terminal device according to a candidate downlink reception beam for receiving the RRC release message.

8. The method according to claim 7, further comprising:
transmitting a data reception success indication to the terminal device in the non-connected state, wherein the data reception success indication indicates that the network-side device has received the data transmitted by the terminal device in the CG-SDT procedure and/or in a CG-SDT retransmission procedure.

9. The method according to claim 8, wherein there is a mapping relationship between a synchronization signal block (SSB) beam and a PUSCH resource; and after transmitting the data reception success indication to the terminal device, and before transmitting the RRC release message to the terminal device, the method further comprises:
determining that the terminal device supports the beam correspondence, and determining a candidate SSB beam according to the dedicated PUSCH resource and the mapping relationship; and
transmitting a PDCCH carrying a C-RNTI to the terminal device on the candidate SSB beam.

10. The method according to claim 9, further comprising:
receiving a PUSCH transmitted by the terminal device in the non-connected state on an uplink SSB beam, wherein the uplink SSB beam is determined by the terminal device according to the candidate SSB beam.

11. (canceled)

12. (canceled)

13. A communication device, comprising a processor and a memory for storing a computer program, wherein the processor, in response to execution of the computer program stored in the memory, causes the device to:
transmit, in a connected state, capability indication information to a network-side device, wherein the capability indication information indicates that the communication device supports beam correspondence in a configured grant small data transmission (CG-SDT) procedure.

14. A communication device, comprising: a processor and an interface circuit, wherein the interface circuit is configured to receive code instructions and transmit the same to the processor; and the processor is configured to execute the code instructions to perform the method according to claim 1.

15. A non-transitory computer-readable storage medium, configured to store instructions, wherein the instructions, when executed, cause the method according to claim 1.

16. A communication device, comprising a processor and a memory for storing a computer program, wherein the processor, in response to execution of the computer program stored in the memory, causes the device to perform the method according to claim 6.

17. A communication device, comprising: a processor and an interface circuit, wherein the interface circuit is configured to receive code instructions and transmit same to the processor; and the processor is configured to execute the code instructions to perform the method according to claim 6.

18. A non-transitory computer-readable storage medium, configured to store instructions, wherein the instructions, when executed, cause the method according to claim 6 to be implemented.
